(19) United States
(12) Patent Application Publication
(10) Pub. No.: US 2022/0245614 A1
(43) Pub. Date: Aug. 4, 2022

(54) Augmented Reality Peer to Peer Payment System

(71) Applicant: Daniel Goddard, Calabasas, CA (US)

(72) Inventor: Daniel Goddard, Calabasas, CA (US)

(21) Appl. No.: 17/592,326

(22) Filed: Feb. 3, 2022

Related U.S. Application Data
(60) Provisional application No. 63/145,947, filed on Feb. 4, 2021.
(60) Provisional application No. 63/176,089, filed on Apr. 16, 2021.

(51) Int. Cl. G06Q 20/32; G06Q 20/22; H04L 51/52; G06T 19/00

(52) U.S. Cl. CPC G06Q 20/3224; G06T 19/006; H04L 51/32; G06Q 20/223

(57) ABSTRACT

A transaction system is provided, comprising a plurality of mobile devices having imaging apparatus and GPS circuitry, a mobile application, each coupled to the Internet. Characterized in that the system, by the execution of the coded instructions by the processor, associates individual mobile devices with a user having a user ID and with an avatar stored in the data repository, receives image data from the mobile devices, processes the image data using AR software, provides AR display data back to the individual mobile devices, and, receiving input from one of the mobile devices signaling intent to transact with another of the mobile devices, updates the AR display of the one mobile device with the avatar of the other mobile device, the avatar enabled as a link.

### CROSS-REFERENCE TO RELATED DOCUMENTS

The instant application claims priority to a U.S. Provisional Patent Application 63,176,089 filed on Apr. 16, 2021 and to a U.S. Provisional Patent Application 63,145,947 filed on Feb. 4, 2021. Both provisional applications are herein incorporated by reference in their entirety.

### BACKGROUND OF THE INVENTION

### 1. Field of the Invention

The present invention is in the technical area of peer-to-peer (P2P) financial transaction systems and pertains more particularly to a system that leverages virtual reality, specifically augmented reality, with avatars representing real persons.

### 2. Description of Related Art

There exist in the art at the time of filing this application a variety of P2P transaction systems enabling payments and the like, but to the inventor's knowledge no such system that presents an avatar representing a registered member of the payment system and enables transactions between members by engaging the avatars in interactive interfaces presented by software executing as a part of a mobile application on a smartphone.

### BRIEF SUMMARY OF THE INVENTION

The present invention provides a peer to peer transaction system involving virtual reality including a first mobile device having imaging apparatus and GPS circuitry, executing a mobile application, coupled to the Internet network. A second mobile device is also added to the system having imaging apparatus and GPS circuitry, executing the mobile application, coupled to the Internet network, and an Internet connected server having a processor executing coded instructions, and coupled to a data repository. The system is characterized by the execution of the coded instructions by the processor in the Internet-connected server, recognizing that the first and the second mobile devices have common GPS coordinates, associates the first mobile device with a first user having a first user ID and a first avatar stored in the data repository, and the second mobile device with a second user having a second user ID and a second avatar stored in the data repository, receives image data from the first mobile device, processes the image data from the first mobile device using Augmented Reality (AR) software, provides AR display data to the first mobile device, the image produced including an avatar of the second user retrieved from the data repository, with the avatar enabled as a link in the display of the first mobile device.

One embodiment includes that the first and the second avatars are created by the first and the second users in a configuration process guided by first use of the mobile application with a requirement that the users upload a photograph taken by the user's mobile device's imaging apparatus during the configuration process. Additionally, in the configuration the users are enabled to enter a social message to be displayed with the user's avatar. In another embodiment, the link associated with the avatar of the second user, when selected in the AR display of the first mobile device, causes the system to update the AR display of the first mobile device with an interactive interface having an input mechanism enabling the first user to select to send money to or request money from the second user. In this embodiment, the input mechanism comprises radio buttons, and upon selection by the first user to send money to the second user, the AR display on the first mobile device is updated to an interactive interface with an input field enabling the first user to enter a money amount to be sent to the second user, and an initiation input that when selected initiates the transaction. Continuing the method, upon selection of the initiation input, the transaction system, executing the coded instructions, leverages third party systems through the Internet network to implement the transaction, debiting an account of the first user and crediting an account of the second user.

In the transaction system the interactive interface enables the first user to enter a money amount further comprises an input field enabling the first user to enter a reason for the payment. Another embodiment provides that the input mechanism comprises radio buttons, and upon selection by the first user to request money from the second user, the AR display on the first mobile device is updated to an interactive interface with an input field enabling the first user to enter a money amount to be requested from the second user, and an initiation input that when selected initiates the transaction. In this embodiment, upon selection of the initiation input, the transaction system, executing the coded instructions, leverages third party systems through the Internet network to implement the transaction, debiting an account of the second user and crediting an account of the first user.

In another embodiment, the transaction system, by the execution of the coded instructions by the processor, associates individual mobile devices with a user having a user ID and with an avatar stored in the data repository, receives image data from the mobile devices, processes the image data using AR software, provides AR display data back to the individual mobile devices, and, receiving input from one of the mobile devices signaling intent to transact with another of the mobile devices, updates the AR display of the one mobile device with the avatar of the other mobile device, the avatar enabled as a link.

One embodiment provides a business account for a specific business linked to the transaction system wherein a first portion of the substantial plurality of mobile devices are associated with customers of the specific business and a second portion of the substantial plurality of mobile devices are associated with employees of the specific business. In this embodiment, the system, by the execution of the coded instructions by the processor, associates individual mobile devices with a user having a user ID and with an avatar stored in the data repository, receives image data from the mobile devices, processes the image data using AR software, provides AR display data back to the individual mobile devices, and, receiving input from one of the mobile devices signaling intent to transact with another of the mobile devices, updates the AR display of the one mobile device with the avatar of the other mobile device, the avatar enabled as a link that leverages functionality enabling customers to implement payments to employees, and wherein payment transactions implemented by customers of the specific business to employees of the specific business are passed through to the business account for the specific business. Also, in this embodiment, a payment pathway from the business account for the specific business to a bank account for the specific business whereby money may be credited to by the transaction system to the bank account for the specific business.

### BRIEF DESCRIPTION OF THE SEVERAL VIEWS OF THE DRAWINGS

FIG. 1 is an architectural diagram illustrating a system in an embodiment of the invention.

FIG. 2 is a first interactive interface presented on a display of a mobile device in an embodiment of the invention.

FIG. 3 is a second interactive interface presented on a display of a mobile device in an embodiment of the invention.

FIG. 4 is a third interactive interface presented on a display of a mobile device in an embodiment of the invention.

FIG. 4 is a fourth interactive interface presented on a display of a mobile device in an embodiment of the invention.

FIG. 5 is a fifth interactive interface presented on a display of a mobile device in an embodiment of the invention.

FIG. 6 is a sixth interactive interface presented on a display of a mobile device in an embodiment of the invention.

FIG. 7 is a seventh interactive interface presented on a display of a mobile device in an embodiment of the invention.

FIG. 8 is an eighth interactive interface presented on a display of a mobile device in an embodiment of the invention.

FIG. 9 is a ninth interactive interface presented on a display of a mobile device in an embodiment of the invention.

FIG. 10 is a tenth interactive interface presented on a display of a mobile device in an embodiment of the invention.

FIG. 11 is an eleventh interactive interface presented on a display of a mobile device in an embodiment of the invention.

FIG. 12 is a twelfth interactive interface presented on a display of a mobile device in an embodiment of the invention.

FIG. 13 is a thirteenth interactive interface presented on a display of a mobile device in an embodiment of the invention.

FIG. 14 is a fourteenth interactive interface presented on a display of a mobile device in an embodiment of the invention.

FIG. 15 is a diagram of a transaction system serving a specific business.

### DETAILED DESCRIPTION OF THE INVENTION

The transaction system that is a subject of the instant patent application is termed by the inventor the SeePay system. A mobile application according to an embodiment of the present invention enables per-to-peer (PTP) interaction between users of the SeePay transaction system. That is, communication and functionality in the system in an embodiment is by direct communication between mobile devices, such as smartphones or pad devices, for example, by different users. In following descriptions a smartphone is used, but other mobile devices capable of Internet access may also be used. A person is enabled to use the SeePay transaction system by downloading the mobile application from a source such as the Apple Store, or another provider of applications, such as a source of Android applications.

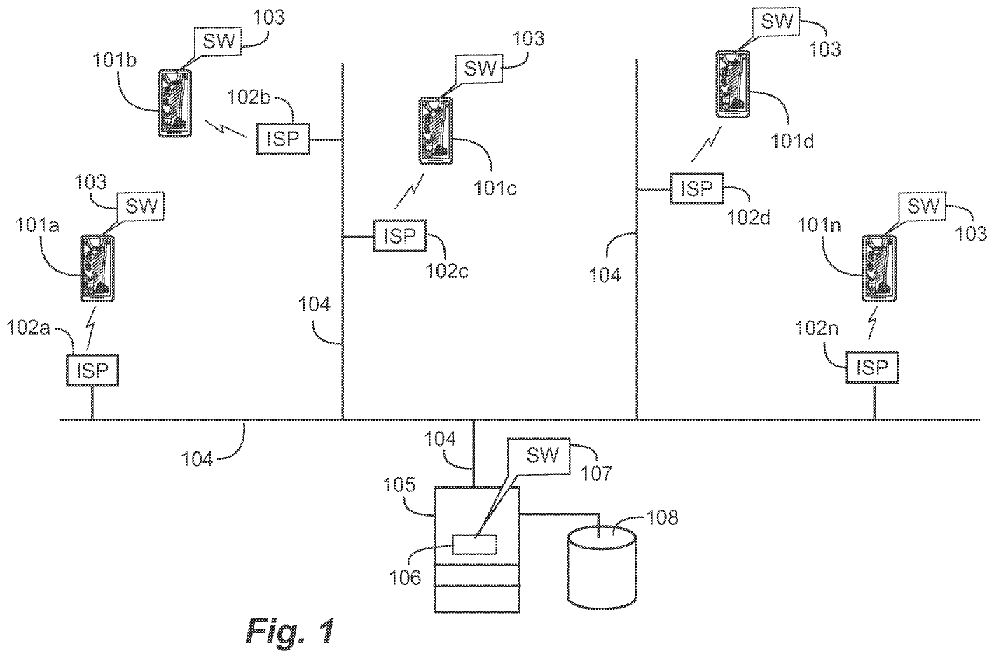

FIG. 1 is an architectural diagram illustrating the SeePay system in one embodiment of the invention. In this example a plurality of smartphones 101a through 101(n) are shown, each executing an application 103, which in this example is the mobile application mentioned above. Some of the platforms 101a through 101n may be Apple devices, and some may be Android, and the platforms will be executing the appropriate mobile application, all designated 103 in FIG. 1.

Persons practicing the SeePay system may be anywhere on Earth, and interaction between smartphones 101(a-n) is over the well-known Internet network, indicated in FIG. 1 by Internet backbone 104, which represents all of the interconnected networks of the Internet. Each active smartphone, or other mobile device, in practicing the SeePay system connects to the Internet via an Internet Service Provider (ISP) 102(a-n). The ISP may be a WiFi modem in a residence or business or may be in some circumstances an ISP operated by a cellular network service in which the mobile device connects over the cellular network then to the Internet. In any case all active mobile devices in FIG. 1 are connected to the Internet.

The SeePay system comprises an Internet-connected server 105 with a central processing unit (CPU) 106 executing software 107. Server 105 is coupled to a digital data repository 108 that in one instance executes a database proprietary to the SeePay system. As persons operating mobile devices 101(a-n) interact with one another via the Internet certain functions are provided to individual ones of the mobile devices by server 105 executing SW 107 and communicating with data repository 108.

As was described above, to practice the SeePay system a person downloads an appropriate version of the SeePay mobile application from an App Store. Upon downloading and initiating the SeePay mobile application the person to become a user is directed through a series of configuration steps. The person is directed in one step to upload a picture of herself or himself. This is not to be a picture stored on the smartphone but must be picture that the user snaps using the smartphone's camera in the configuration process in real time. This restriction assures that the picture identifies the person as correctly as possible.

The picture becomes an avatar associated with the user in functionality of the system. The Avatar for each user is stored in data repository 108 coupled to Internet-connected server 105. The person in this configuration process also must authorize GPS location of his or her mobile device at least while the SeePay mobile application is executing. Users must also be registered with one or another of third-party systems that do transactions, like, for example, Stripe™. Other third-party systems may be leveraged as well, such as Plaid™. A user ID is assigned for each user at configuration, is stored in the database in repository 108, and may be resolved into a stripe ID. GPS is commonly not involved in identification, only for discovery

SeePay uses Augmented Reality (AR) device platforms (smartphones) or other Internet-capable platforms in order to position objects/posts in AR space in interactive AR displays provided to the users. Each object/post has a GPS location. Using the user's device GPS and compass data the object/post is positioned at a correct distance and direction in ARKit/ARCore world coordinates overlaid on a 3D grid that surrounds the user when using camera view when entering an AR mode. Since it is desirable to show each object/post at the same size, the object/post size is changed based on distance from the user in a display. This way the objects are at the same distance from the user's point of view, while in reality the objects can be near or far away. SeePay processes the device GPS raw data using algorithms like a Low Pass Filter to filter out noises and errors (due to low signal or indoor position) and makes updates to the server only when the updates are known to be relevant. For example, an update may be made if some movement is detected in a preprogrammed time span. The process of location management, update location and search for nearby users is managed by SW 107 (see FIG. 1) in a manner that allows an unlimited number of users to be updated in their location and to receive updates from the database in real-time.

SeePay detects that AR posts are moving according to the user's updated location every time the user moves. This data is represented by a new position in the 3D space/translated into new 3D coordinates. In addition, the system adjusts the product through the server for different users in different locations, like changing the radius of finding nearest neighbors. For example, a 5 km radius may be used in Los Angeles while a 30 km radius may be used in Colorado.

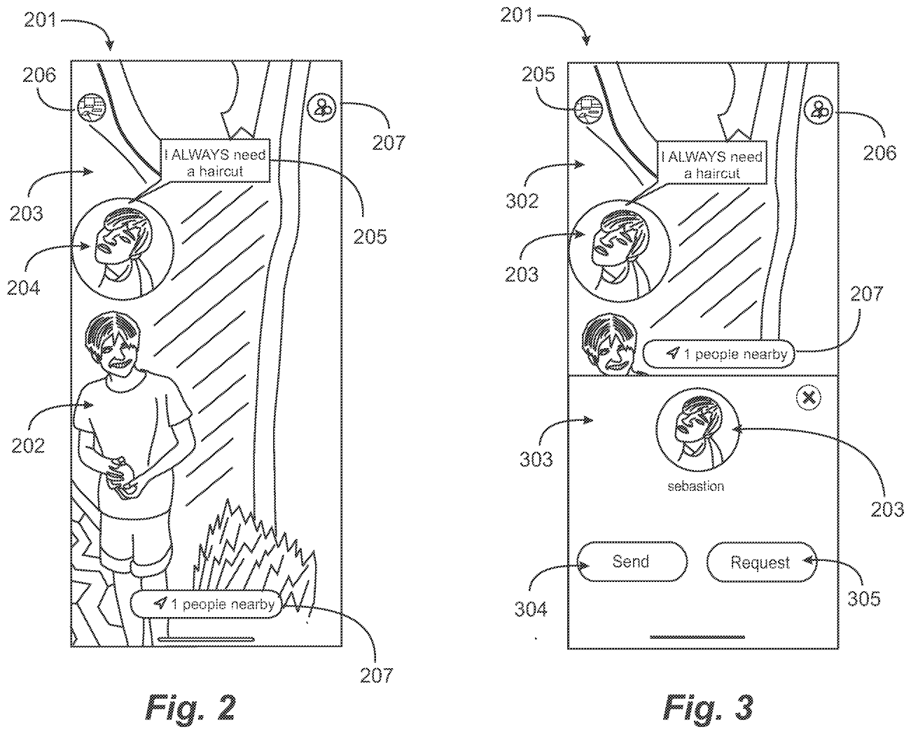

FIG. 2 is an interactive interface presented on a display of a mobile device 201 executing an instance of the mobile application represented as SW 103 in FIG. 1. Device 201 may be one of the devices 101(a-n) of FIG. 1. The user of mobile device 201 is pointing the camera of the device toward, in this example, another member 202, Sabastion, of the SeePay system. Display 203 shows Sebastion standing with trees and shrubbery in the background.

Mobile device 201, executing an instance 103 of the mobile application is in communication over the Internet network with server 105 executing SW 107 by processor 106, coupled to data repository 108. In the particular coupling of device 201 and the server, SW 107 has real-time GPS data for device 201. Processes of location management, update location and a search for nearby users is managed by SW 107 (see FIG. 1) in a manner that allows an unlimited number of users to be updated in their location and to receive updates from the database in real-time.

In this example, the system notes a nearby user Sebastion with GPS coordinates essentially the same as the person in the image on the display of device 201, and concludes that there is 1 people nearby, which is posted in an overlay window 207 on display 202. It should be understood that there may be other users nearby, but not as close as Sebastion, and that circumstance window 207 would indicate more users nearby.

Having concluded that the person in the display from device 201 may well be Sebastion, the system retrieves the Avatar for Sebastion, which Sebastion will have provided in his configuration, and posts the Sebastion Avatar 203, along with his social message 204, in the AR display being transmitted back to device 201. Sebastion's Avatar 203 and message 204 are seen in FIG. 2 in the AR display. Icon 205 is an Interactive App button that the system provides in AR display enabling the user to select (click on) that button to access his or her own profile information and App settings stored in repository 108. Icon 206 is an interactive App button that the user may select to search for other users, by entering a name or other ID. This opens functions that allow the user to pay to or request money from other SeePay users independent upon the AR or seeing the other user in the display. This functionality is described further in enabling detail below.

As the instant user selects (clicks on) the avatar the interactive interface updates as seen in FIG. 3, providing an overlay 303 showing Sebastion's avatar 203, but without a link, enabling the instant user to select by radio buttons 304 or 305 to send money to or request money from Sebastion. There is an exit link in the upper right corner, enabling the user to opt out of the function.

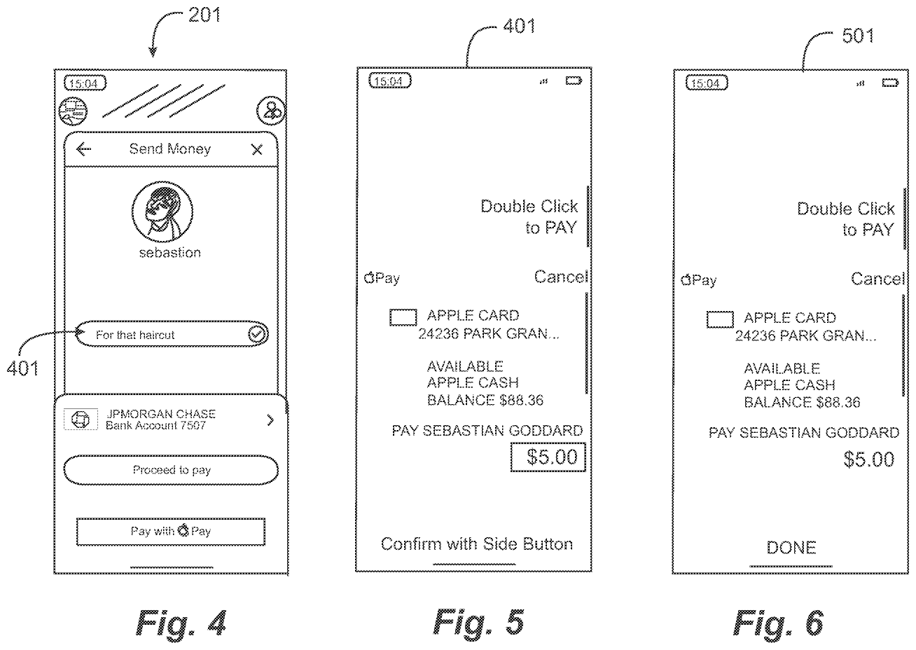

Assuming the user decides to send money to Sebastion, he or she clicks the send button 304, and the display updates to the display illustrated in FIG. 4. An overlay titled “Send Money” indicates that process has been selected. The user may enter a message in input field 401, perhaps indicating a reason for the payment. In this case the reason being to pay for a haircut. Selections are provided for the user to pay through his/her account at JP Morgan Chase, or may select to pay through Apple Pay.

FIG. 5 illustrates an overlay that indicates the user selected to pay through Apple Pay. This overlay provides ID of the Apple account, available Apple cash and an input field for the user to indicate the amount to pay. In this example the amount entered is $5.00. There is an instruction “Double-Click to pay, and an instruction “Confirm with Side Button. FIG. 6 Simply updates the display of FIG. 5 with an indication “Done” at the bottom of the display.

The SeePay application leverages GPS to locate other users relative to the location of the instant user's device, and to engage other users. These users may be viewed directly in the display, via a camera in a smartphone device or other Internet connected computerized device that includes a camera, other users may be accessible as well.

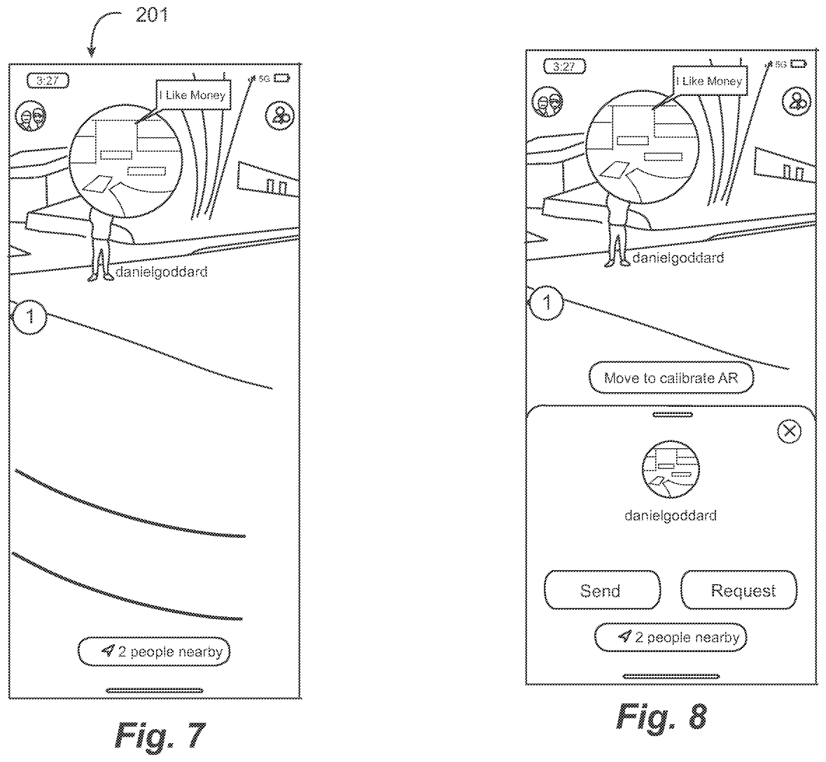

In an example of use shown in FIG. 7 the instant user directing his device's camera is a young man (Daniel's son Sebastion). The display shows Daniel standing in Daniel's driveway. Daniel's avatar is also displayed with his social message “I like money”. The number 1 on the left of the screen indicates another SeePay user nearby, and 2 other users are indicated at the bottom of the display.

The instant user Sebastion touches the Avatar of Daniel Goddard displayed in the AR display and is presented with a Sen/Request option as seen in FIG. 8. Sebastion now may select to send money to Daniel, or request money from Daniel with functionality as indicated above. A further feature provided through the execution of SW 107 on the server enables the instant user to swipe left or right on the “Send/Request” overlay resulting in other SeePay members nearby being presented in the “Send/Request” overlay, and may then initiate and accomplish payment or requests with a different member.

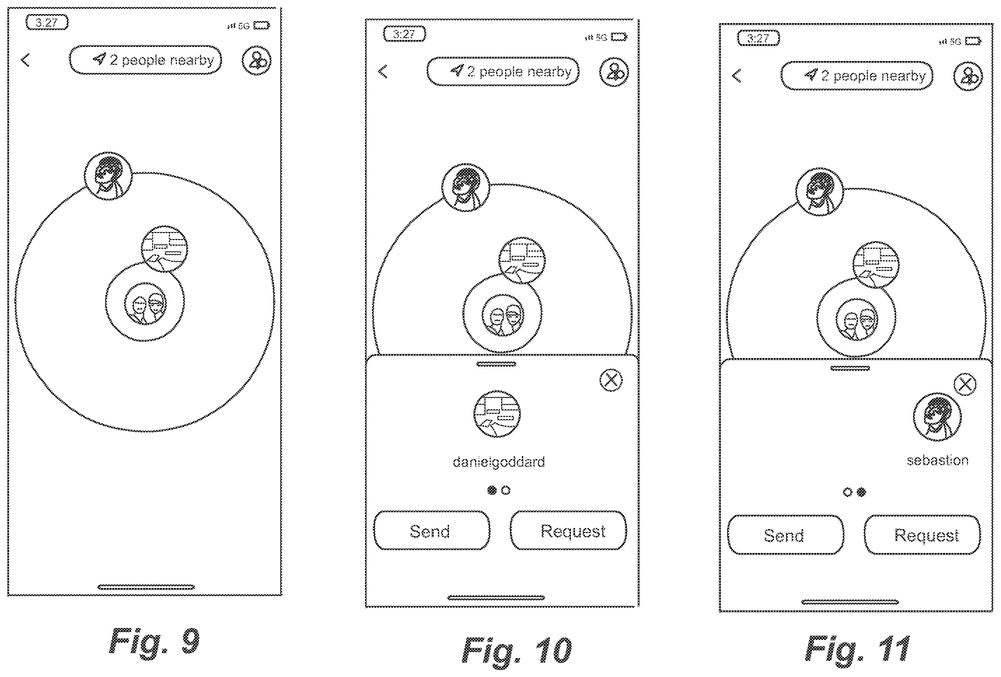

The SeePay application also features an alternative 2D radar-like function for seeing other SeePay users nearby, with the instant user being the epicenter. This is shown in FIGS. 9. 10 and 11.

FIG. 9 illustrates a radar rendition showing the instant user at the center, and two other users (as avatars) in locations related to the epicenter. The fact of two people nearby is also shown on the interface in FIG. 8. FIG. 9 illustrates the interface update when the instant user selects one of the nearby users (Daniel). The Send or Request buttons are displayed as well and may be selected. FIG. 10 shows the update if one of the other nearby users is selected (Sebastion). A user can also touch an avatar in 2D mode, then swipe left or right on the opaque Send/Request overlay, to select between other SeePayer members nearby to send or request money to or from a selected user. FIG. 11 shows the AR display if Sebastion is selected rather than Daniel.

SeePay also provides an ability (function) for a user to search for other SeePay users worldwide who have profiles on the SeePay application. A user can also send or request money from to or from any one of these Worldwide Users. In this embodiment, the Avatar may be placed over a geographic area of a map of a neighborhood, city, state and/or country.

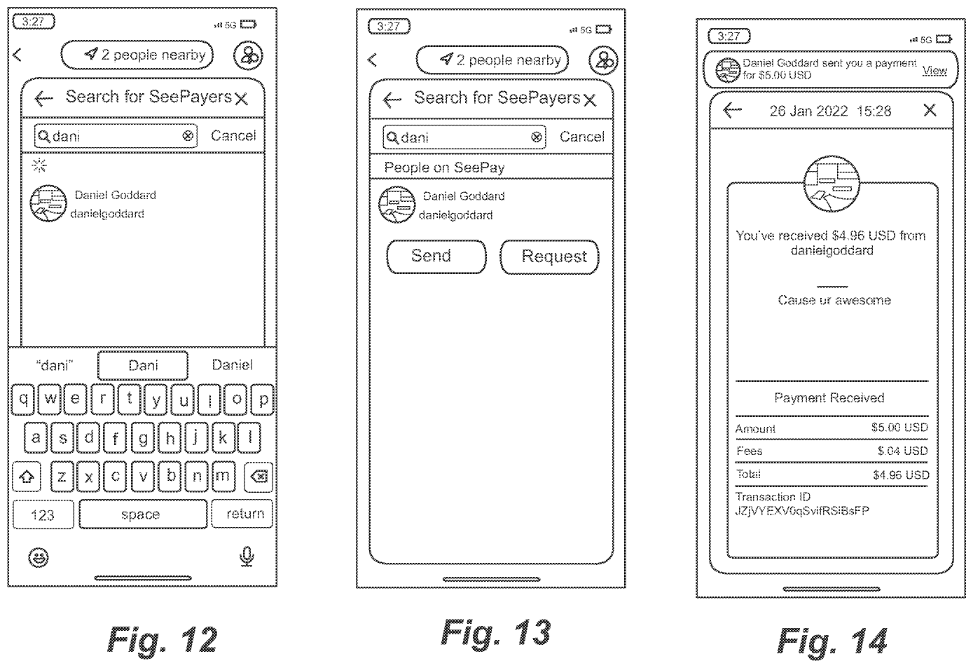

FIG. 12 illustrates an interactive display for a Search function whereby the instant user may enter names or other identification and search for users of the SeePay application. In this example the instant user has typed “dani” in a query field, using a virtual keyboard provided in the display, and the system has responded with the avatar for Daniel Goddard.

FIG. 13 shows the result of the instant user selecting the avatar for Daniel Goddard, which again produces the “Send” “Request” overlay, which enables the instant user to send money to or request money from Daniel Goddard, by selecting the appropriate radio button. The functionality to implement the transaction has been described above.

Users receive SeePay transaction receipts for all successful transactions plus a personal payment message if included. This receipt in one example is shown in the updated display of FIG. 14. The receipt indicates that a payment was requested from Daniel Goddard of $5.00 USD, and was transacted with a fee of $0.04 USD. A transaction ID is provided in the receipt.

A user may also touch an avatar in 2D mode, then swipe left or right (on the opaque Send/Request overlay, as described above) to select between other SeePay members nearby to send or request money.

The SeePay system is believed by the inventors to be more secure than existing systems, because in existing systems a person may easily send money to the wrong person on PayPal, Venmo and Cash App, which are the most used of P2P payment systems by either entering the wrong username, because the user may not be sure of the person's username or, because of a simple typo. Paypal rules state that if you send money to the wrong person, first, you must contact that person to ask for your money to be returned. You can tell Paypal if the user refuses and Paypal says it will investigate, and if there is evidence of a genuine mistake, and the recipient doesn't dispute the claim, it will help customers to get their money back. The moment a payment is sent in Venmo, the funds are made available to the recipient. if a person has sent a payment to another user with a similar name, as a first step, the person must send that user a charge request for the same amount of the payment so they can pay you hack. A note asking them to pay you hack for the money you sent by mistake should be included, and once they accept the request the payment will be added to your Venmo account. On Cash App, it may be impossible if the receiver has accepted the payment and is not willing to send it back.

SeePay's Visual Payment Technology prevents users from making this common mistake by allowing users to actually see the person they are paying or requesting payment from, right in front of them or, at any distance they can see the avatar of the person plus their “Social Message” in Augmented Reality. The person selected to be paid may be in line of sight of the user, wherein the user sees the actual person and the avatar, simultaneously, when GPS places the location of the person, or the person is not in line of site of site, but may still be paid when GPS places their location and displays the avatar.

The SeePay application associates real time GPS location with individual user profiles by storing locations for each user ID in a central database in data repository 108 (FIG. 1). An avatar image URL can be looked up for each user by ID. Avatar selection sets the associated avatar's user ID as a transaction target.

There is a hosted SeePay API. When the avatar and payment method is selected, the device creates a new transaction via the API which uses an online payment infrastructure, for example, the Stripe or Plaid API to create a charge. Credit card and bank account details are never sent to the SeePay API, only Stripe or Plaid handles credit card and bank account details.

Every avatar has an associated user ID which the SeePay API may resolve to a stripe ID. GPS is commonly not involved in identification, only for discovery. Plaid is used solely for fetching bank account information which is linked to the user's Stripe account. Stripe is used for Wallet implementation and for any financial transaction in the system. Each user in the SeePay system has a unique Stripe Connect account and a unique Stripe customer, created when the user has completed registration, and these are stored in the central database.

In another aspect of the invention the SeePay system implements centralized visual payment technology (CVP) wherein individual employees of a business, denoted here as Business X, may be registered users of the SeePay system as described above, complete with ID and avatars, and may transact with customers of the business who are also SeePay users.

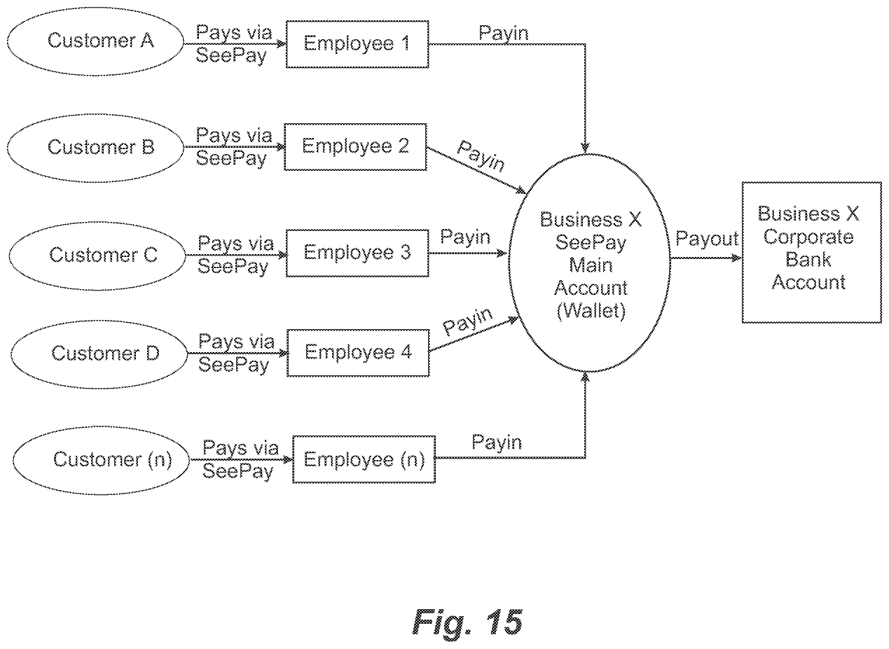

FIG. 15 is a diagram of a centralized payment process for Business X, illustrating customers (A-n) of business X, representing an unlimited number of customers, transacting with employees (1-n) of Business X. All of them customers and employees represented in FIG. 15 are users of the SeePay system, having each an avatar and an ID. In this embodiment, although only one customer to one employee is illustrated, it is to be understood that numerous customers may pay one or more employees. As an individual one of the customers pays an employee the payment is channeled by the SeePay system to a SeePay main account for business X, also termed a Wallet, as illustrated. Business X may choose to leave balances in the wallet or transfer the amounts through suitable software, to business X's corporate bank account. The employee is a contactless conduit for the business to receive customer payments directly at the time of service. In this manner any one business having one Main Account may have numerous portals to receive payments via employee persona and avatar.

Instances of SeePay's CVP process may be billed as a premium service to business clients on a sliding scale per month, with discounted annual purchase options available.

A person of ordinary skill in the art will understand that the embodiments and examples illustrated and described herein are entirely exemplary, and not limiting to the scope of the invention. The interfaces may be updated and implemented in different ways to accomplish the functions described.

1. A transaction system, comprising:
a first mobile device having imaging apparatus and GPS circuitry, executing a mobile application, coupled to the Internet network;
a second mobile device having imaging apparatus and GPS circuitry, executing the mobile application, coupled to the Internet network;
an Internet connected server having a processor executing coded instructions, and coupled to a data repository;
characterized in that the system, by the execution of the coded instructions by the processor in the Internet-connected server, recognizes that the first and the second mobile devices have common GPS coordinates, associates the first mobile device with a first user having a first user ID and a first avatar stored in the data repository, and the second mobile device with a second user having a second user ID and a second avatar stored in the data repository, receives image data from the first mobile device, processes the image data from the first mobile device using Augmented Reality (AR) software, provides AR display data to the first mobile device, the image produced including an avatar of the second user retrieved from the data repository, with the avatar enabled as a link in the display of the first mobile device.

2. The transaction system of claim 1 wherein the first and the second avatars are created by the first and the second users in a configuration process guided by first use of the mobile application with a requirement that the users upload a photograph taken by the user's mobile device's imaging apparatus during the configuration process.

3. The transaction system of claim 2 wherein, in the configuration the users are enabled to enter a social message to be displayed with the user's avatar.

4. The transaction system of claim 1 wherein the link associated with the avatar of the second user, when selected in the AR display of the first mobile device, causes the system to update the AR display of the first mobile device with an interactive interface having an input mechanism enabling the first user to select to send money to or request money from the second user.

5. The transaction system of claim 4 wherein the input mechanism comprises radio buttons, and upon selection by the first user to send money to the second user, the AR display on the first mobile device is updated to an interactive interface with an input field enabling the first user to enter a money amount to be sent to the second user, and an initiation input that when selected initiates the transaction.

6. The transaction system of claim 5 wherein, upon selection of the initiation input, the transaction system, executing the coded instructions, leverages third party systems through the Internet network to implement the transaction, debiting an account of the first user and crediting an account of the second user.

7. The transaction system of claim 5 wherein the interactive interface enabling the first user to enter a money amount further comprises an input field enabling the first user to enter a reason for the payment.

8. The transaction system of claim 4 wherein the input mechanism comprises radio buttons, and upon selection by the first user to request money from the second user, the AR display on the first mobile device is updated to an interactive interface with an input field enabling the first user to enter a money amount to be requested from the second user, and an initiation input that when selected initiates the transaction.

9. The transaction system of claim 8 wherein, upon selection of the initiation input, the transaction system, executing the coded instructions, leverages third party systems through the Internet network to implement the transaction, debiting an account of the second user and crediting an account of the first user.

10. A transaction system, comprising:
a substantial plurality of mobile devices having imaging apparatus and GPS circuitry, executing a mobile application, each coupled to the Internet network;
an Internet connected server having a processor executing coded instructions, and coupled to a data repository;
characterized in that the system, by the execution of the coded instructions by the processor, associates individual mobile devices with a user having a user ID and with an avatar stored in the data repository, receives image data from the mobile devices, processes the image data using AR software, provides AR display data back to the individual mobile devices, and, receiving input from one of the mobile devices signaling intent to transact with an other of the mobile devices, updates the AR display of the one mobile device with the avatar of the other mobile device, the avatar enabled as a link.

11. The transaction system of claim 11 wherein the avatars are created by the users in a configuration process guided by first use of the mobile application with a requirement that the users upload a photograph taken by the user's mobile device's imaging apparatus during the configuration process.

12. The transaction system of claim 12 wherein, in the configuration the users are enabled to enter a social message to be displayed with the user's avatar.

13. The transaction system of claim 11 wherein the link associated with the avatar of the other user, when selected in the AR display of the one mobile device, causes the system to update the AR display of the one mobile device with an interactive interface having an input mechanism enabling the one user to select to send money to or request money from the other user.

14. The transaction system of claim 14 wherein the input mechanism comprises radio buttons, and upon selection by the one user to send money to the other user, the AR display on the one mobile device is updated to an interactive interface with an input field enabling the one user to enter a money amount to be sent to the other user, and an initiation input that when selected initiates the transaction.

15. The transaction system of claim 15 wherein, upon selection of the initiation input, the transaction system, executing the coded instructions, leverages third party systems through the Internet network to implement the transaction, debiting an account of the one user and crediting an account of the other user.

16. The transaction system of claim 14 wherein the input mechanism comprises radio buttons, and upon selection by the one user to request money from the other user, the AR display on the one user's mobile device is updated to an interactive interface with an input field enabling the one user to enter a money amount to be requested from the other user, and an initiation input that when selected initiates the transaction.

17. The transaction system of claim 18 wherein, upon selection of the initiation input, the transaction system, executing the coded instructions, leverages third party systems through the Internet network to implement the transaction, debiting an account of the other user and crediting an account of the one user.

18. The transaction system of claim 11 further comprising a search function selectable by a user in the AR display of the mobile device of that user, enabling that user to enter search criteria leading to discovery of individual other users of the transaction system, and to signal intent to transact with a user returned as a result of a search.

19. A transaction system, comprising:
a substantial plurality of mobile devices having imaging apparatus and GPS circuitry, executing a mobile application, each coupled to the Internet network;
an Internet connected server having a processor executing coded instructions, and coupled to a data repository;
a business account for a specific business linked to the transaction system;
wherein a first portion of the substantial plurality of mobile devices are associated with customers of the specific business and a second portion of the substantial plurality of mobile devices are associated with employees of the specific business;
characterized in that the system, by the execution of the coded instructions by the processor, associates individual mobile devices with a user having a user ID and with an avatar stored in the data repository, receives image data from the mobile devices, processes the image data using AR software, provides AR display data back to the individual mobile devices, and, receiving input from one of the mobile devices signaling intent to transact with an other of the mobile devices, updates the AR display of the one mobile device with the avatar of the other mobile device, the avatar enabled as a link that leverages functionality enabling customers to implement payments to employees;
and wherein payment transactions implemented by customers of the specific business to employees of the specific business are passed through to the business account for the specific business.

20. The transaction system of claim 22 further comprising a payment pathway from the business account for the specific business to a bank account for the specific business whereby money may be credited to by the transaction system to the bank account for the specific business.
